(19) United States
(12) Patent Application Publication
(10) Pub. No.: US 2001/0043471 A1
(43) Pub. Date: Nov. 22, 2001

(54) Fixed device for the bulb socket

(76) Inventor: Chi Hua Lin, Hsin-Chu Hsien (TW)

Correspondence Address: RABIN & CHAMPAGNE, P.C., 1101 14 Street, N.W., Suite 500, Washington, DC, 20005, US

(21) Appl. No.: 09/892,555

(22) Filed: Jun. 28, 2001

Related U.S. Application Data
(63) Continuation-in-part of application No. 09/546,175, filed on Apr. 11, 2000.

(51) Int. Cl. H01R 24/00; H01R 33/00

(52) U.S. Cl. 362/226; 439/699.2

(57) ABSTRACT

The present invention provides a C.I.P. of U.S. patent application Ser. No. 09/546,175, namely, an improved device for the bulb socket. This refers to a jacket set at the caulking part above the fixture of the bulb socket. There are several jack catches inside the jacket. Besides, the outer part of the bulb is added with several convex catches. When the bulb is inserted into the fixture of the bulb socket, the convex catches of the bulb will be geared between the jack catches within the jacket. Such an engagement can fix the bulb with the fixture of the bulb socket more effectively.

This present application represents a continuation-in-part (C.I.P) of U.S. patent application Ser. No. 09/546,175 field on Apr. 11, 2000, which is entirely been incorporated herein by reference.

### TECHNICAL FIELD

The present invention provides a C.I.P. of U.S. patent application Ser. No. 09/546,175, namely, an improved fixed device for the bulb socket. It particularly refers to a jacket set on the said fixed device for the bulb socket and a numbers of jack catches set inside the jacket for fixation to the bulb.

### BACKGROUND OF THE INVENTION

The inventor applied for U.S. patent application Ser. No. 09/546,175, in which, a concave ratchet-shaped jack catch as a stopping device disposed on every flank of the leading-in socket of the bulb socket, and a convex ratchet-shaped jack catch as a resistance device disposed inner-side the fixing frame. During fabrication, by utilizing the said fixing frame to connect with the leading-in socket of the bulb socket, which means the stopped device will gear with the resistance device in a secure combination. Hence, a firmly connection of the fixing frame and the leading-in socket which serves to avoid the operation in a heat pressing and to solve a secure connection than a conventional high-frequency soldering.

The above mentioned is only explicated the connection between the leading-in socket and the fixing frame. However, no better solution of the connection between the bulb and the bulb socket was disclosed. In the past, as the bulb was fabricated onto the bulb socket, of its fixation was not fastening enough which reduced to the bulb in a slippage.

According to above mentioned problems, the inventor bases on his experiences of producing and designing relevant products for many years and devotes to his active efforts for improving them through research, hence a result of the present invention is developed.

A chiefly object of the present invention is to provide a device for effectively fixing the bulb on the bulb socket.

Secondly, the invention has designed the jack catch inside the jacket to reinforce the connection between the bulb and the bulb socket.

In order for the members of the examination committee are enable to further understand the objects, features and functions of the invention, a example as well as drawings are offered as follows:

### A BRIEF DESCRIPTION OF DRAWINGS

FIG. 1: The compound drawing of the invention.

FIG. 2: The breakdown drawing of the invention.

FIG. 3: The side-elevation drawing of the invention.

FIG. 4: The composed plan-view drawing of the invention.

### A BRIEF DESCRIPTION OF COMPONENT NUMBERS

(20) bulb socket.

(21) leading-in socket.

(22) jacket.

(23) caulking groove.

(30) bulb

(31) convex catch.

(32) bulb-neck.

(33) filament joint.

(211) hole.

(221) jack catch.

### A DETAILED DESCRIPTION OF THE INVENTION

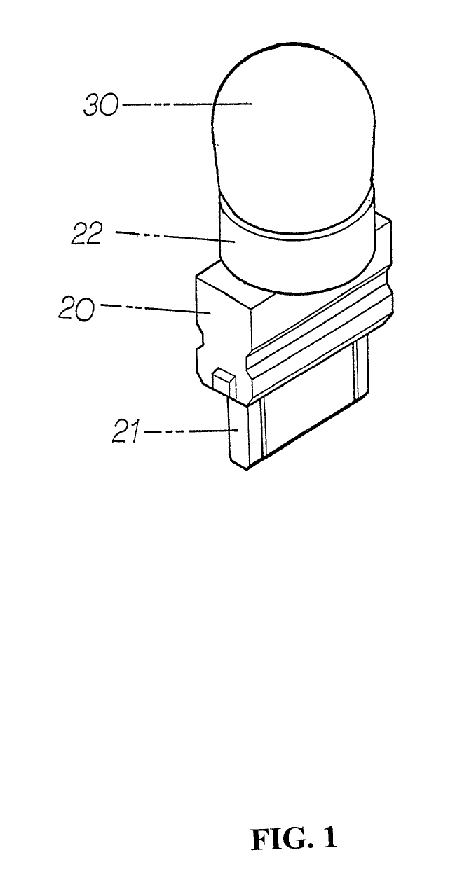

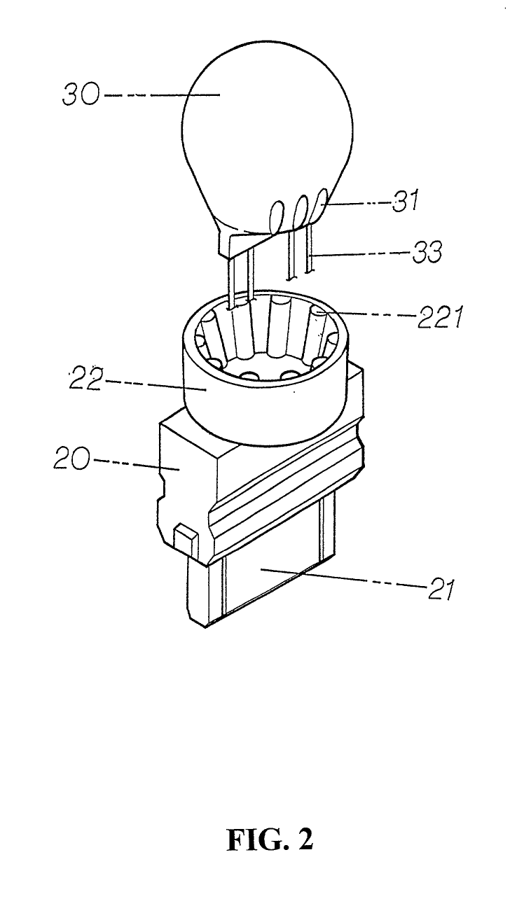

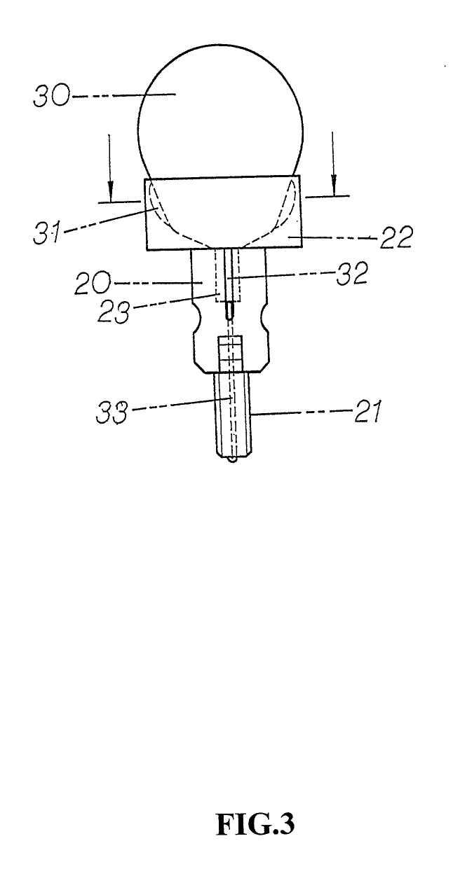

Please refer to FIGS. 1 and 2 as an example to illustrate the improved device for the bulb socket is composed of a bulb socket (20) and a jacket (22). Of the bulb socket (20), please refer to FIGS. 1, 2 and 3, which is as an integrated form and made of engineering plastics and a flat leading-in socket (21) extended from one of its end.

There is a caulking groove (32) on the plane part of the bulb socket (20). The caulking groove (32) is encircled by a jacket (22). There are ten jack catches (221) inside the jacket (22). There are three convex catches (31) around the bulb (30). Besides, there are three convex catches (31) opposite to it. The neck (32) of the bulb (30) is connected with four electric filament joints (33) fixed on the bulb socket (20). When connected, the bulb-neck (32) can be inserted into the caulking groove (23) while the filament joint (33) goes through the leading-in socket (21). Furthermore, the filament joint (33) is bent and flatly attached onto the surface of the leading-in socket (21) for forming the positive and negative electric wires.

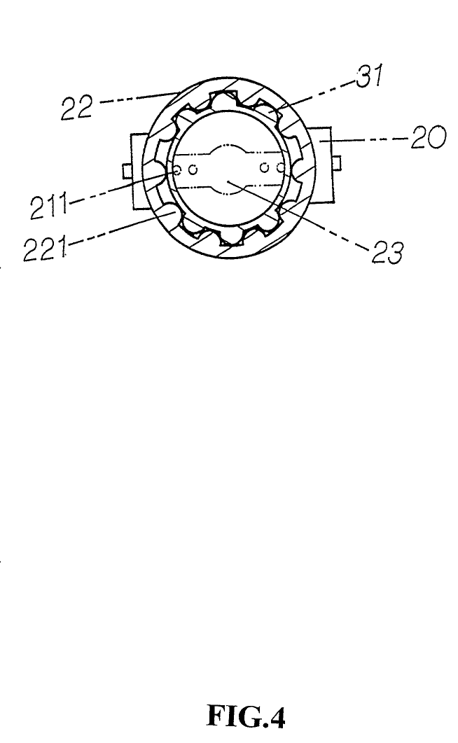

Please refer to FIGS. 2, 3 and 4, as the invention in fabricating means for utilizing the structure as mentioned above. The filament joint (33) of the bulb (30) is direct corresponding to the hole (211) on the base of the leading-in socket (21), in which for inserting the entire bulb (30) from upwardly to bottomwardly, then into the jacket (21) of the bulb socket (20). Thus, the filament joint (33) will go through the leading-in socket (21) and the filament joint (33) will further be bent and flatly to be attached onto the surface of the leading-in socket (21) for forming the positive and negative electric wires. As the said structure in integrated, each convex catch (31) outside the bulb (30) will be geared with the jack catch (221) inside the jacket (22) as well as integration of every jack catch (221). This is a more secure fixture for the bulb (30) and bulb socket (20) than others.

All in all as mentioned above, the practicability of this invention goes beyond doubts and conforms to the legal stipulations required by patent laws, accordingly, this application is applying for this matter.

What is claimed is:

1. An improved fixed device for the bulb socket chiefly refers to the fixation of a bulb with one end of the bulb socket, of a leading-in socket extended from the other end of the said bulb socket to connect with one or more electric wires, herein mainly features as following:
At the top of the bulb socket is surrounded by a jacket, there one or more jack catches allocated on the said jacket and one or more convex catches allocated on the said bulb; means
In connecting of the bulb onto the bulb socket, where the convex catches of the bulb will be geared with jack catches of every jack for enforcing the secure connection of the bulb and bulb socket.

2. According to claim 1 of an improved device for the bulb socket, for coordinating with the jacket of the said bulb socket in a fixation, where three convex catches added at a certain outer section of the bulb and three convex catches added at the opposite direction of the said section; according to an amount of six convex catches on the outer section of the bulb for exactly geared with the convex catches inside jacket.

3. According to claim 1, an improved device for the bulb socket, ten jack catches allocated inside of the jacket of the said bulb socket in a fixation for exact gearing and secure connection the said ten jack catches with the convex catches of the bulb.
